(19) United States
(12) Patent Application Publication
(10) Pub. No.: US 2021/0056608 A1
(43) Pub. Date: Feb. 25, 2021

(54) METHODS AND SYSTEMS FOR PRODUCT SEARCHES

(71) Applicant: Shopify Inc., Ottawa (CA)

(72) Inventors: Rahul Kulkarni, Waterloo (CA); Andrez Piotr Paliga, Ottawa (CA); Nicolas DeFrancesco, Ottawa (CA); Jiangtao Hong, Toronto (CA); Mauricio Sierra, Toronto (CA); Ryan Balsdon, Kanata (CA)

(21) Appl. No.: 16/550,011

(22) Filed: Aug. 23, 2019

(51) Int. Cl. G06Q 30/06; G06Q 30/02; G06F 16/955

(52) U.S. Cl. CPC G06Q 30/0629; G06Q 30/0619; G06F 16/955; G06Q 30/0222; G06Q 30/0223

(57) ABSTRACT

Search mechanism includes concurrent competitive pricing analysis, initiated during purchase workflow such as inventory or product search by merchant or customer. Recommendation for promotion or discount can be provided and automatically applied without review by a manager. Promotion can be discount, quantity, shipping or other desirable upgrade. Pricing analysis may utilize SKU, UPC, product name or other attribute. Single draft order combines purchases from offline and online channels and properly attributes origination of purchases resulting in increased accuracy of sales metrics for commissions or marketing efforts or other metrics. Draft order identifier can transmit the draft order to customer, point of sale or merchant devices, which can utilize QR code, NFC, SMS, email or other means. Single draft order can be presented and converted to a transaction on customer, point of sale or merchant devices.

### FIELD

The present disclosure relates to methods and systems for products searches in electronic commerce.

### BACKGROUND

Frequently merchants have offline sales channels (e.g. brick and mortar retail stores) as well as online sales channels (e.g. e-commerce websites). For example, problems arise for both merchants and customers when pricing, availability or other terms are different between an offline channel (e.g. in a brick-and-mortar or physical store) and an online channel such as an online store. These problems are significantly compounded when a customer is incentivized to make purchases on a channel not ideal for the merchant (for example, a channel without inventory) or a combination of both channels.

In many situations, offline commerce may be at a disadvantage to online commerce. For example, a prospective customer may enter a physical store with the intention to purchase a product, but sufficient inventory is not available at the retail store. In other situations, a customer may visit a retail store merely to examine an actual product (e.g. check the quality and/or fit, and the like) or establish other necessary credentials (e.g. discussing the product with a salesperson), without their intention to purchase at the retail store (e.g. intending to purchase online). In these situations, a sale that could or should have occurred at the local retail store may be lost to an online store (which may be an online channel of the same merchant as the physical store or an online store of a different merchant).

### SUMMARY

In an aspect, a computer-implemented method of combining multi-channel prospective purchases is disclosed, including: receiving a first prospective purchase on an offline channel; receiving a second prospective purchase on an online channel; and combining the first prospective purchase and the second prospective purchase into a single or common draft order. In embodiments, the single draft order may properly attribute origination of the first prospective purchase and the second prospective purchase via a salesperson ID associated with the offline channel. The single draft order may properly attribute origination of the first prospective purchase and the second prospective purchase via a store ID associated with the offline channel. The single draft order may properly attribute origination of the first prospective purchase and the second prospective purchase via a location ID associated with the offline channel. The single draft order may properly attribute origination of the first prospective purchase and the second prospective purchase to the offline channel resulting in increased accuracy of sales metrics. The method may include communicating the single draft order to a customer. The step of communicating the single draft order to the customer may include a merchant providing checkout services to the customer. The step of communicating the single draft order to the customer may include providing a draft order identifier to the customer. The draft order identifier may be a link. The draft order identifier may be a QR code. The draft order identifier may be an NFC. The draft order identifier may be provided via SMS. The draft order identifier may be provided via email. The draft order identifier may be provided via an application notification. The draft order identifier may be utilized by a customer device. The step of communicating the single draft order to the customer may include providing a split-cart user interface. The method may include converting the single draft order into a single transaction. The step of converting the single draft order to the single transaction may occur via authorization provided on a POS device. The step of converting the single draft order to the single transaction may occur via authorization provided on a merchant device. The step of converting the single draft order to the single transaction may occur via authorization provided on a customer device.

In an aspect, a computer-implemented method for automatically determining a recommended promotion to provide to a customer is disclosed, including: receiving a prospective purchase; automatically performing a promotion analysis on a product of the prospective purchase; and automatically determining the recommended promotion based on the promotion analysis. In embodiments, the prospective purchase may originate from an offline channel. The prospective purchase and the customer may be located at an offline channel. The prospective purchase may be a draft order. The draft order may be a multi-channel draft order including an offline channel and an online channel. The promotion analysis may be automatically performed upon a product inventory search by a merchant. The recommended promotion may be automatically approved without approval of a manager. The method may include communicating the recommended promotion to a merchant. The method may include communicating the recommended promotion to a customer. The step of performing a promotion analysis may utilize a SKU of the product. The step of performing a promotion analysis may include performing a price analysis of the product from one or more in a set containing competitor offerings and historical data. The step of performing a promotion analysis may include performing an inventory analysis of the product from one or more in a set containing competitor offerings and historical data. The step of performing a promotion analysis may include performing a demand analysis of the product. The step of performing a promotion analysis may include performing a value analysis of the prospective purchase. The recommended promotion may be a discount as a percentage. The recommended promotion may be a discount as a fixed currency amount. The recommended promotion may be an increase in quantity of the product. The recommended promotion may be an upgrade of the product. The recommended promotion may be a discount on shipping. The recommended promotion may be a free shipping upgrade.

In an aspect, a computer-implemented method for performing a competitive online search of a product is disclosed, including: identifying a merchant-initiated step in a product purchase flow of the product; performing the concurrent competitive online search of the product upon the merchant-initiated step of the product purchase flow; and presenting a result of the concurrent competitive online search. In embodiments, the merchant-initiated step in the product purchase flow may be a product inventory search. The merchant-initiated step in the product purchase flow may be creation of a draft order. The draft order may be a multi-channel draft order including an offline channel and an online channel. The product may be not in inventory at a store location where the merchant-initiated step occurs. The result of the concurrent competitive online search may be presented to a merchant. The result of the concurrent competitive online search may be presented to a customer. The step of presenting the result may include automatically determining a recommended promotion. The recommended promotion may be a discount. The recommended promotion may be automatically applied to a purchase transaction for the product. The step of presenting the result may include presenting the recommended promotion on a merchant device. The step of presenting the result may include presenting the recommended promotion on a POS device. The merchant-initiated step in the product purchase flow may be a product inventory search; the product may be not in inventory at a store location where the merchant-initiated step occurs; the step of presenting the result may include automatically determining a recommended discount; the result of the concurrent competitive online search are presented to a merchant device; and the recommended discount may be automatically approved without a review by a manager.

In an aspect, a computer-implemented method for performing a competitive online search of a product is disclosed, including: identifying a merchant-initiated step in a product purchase flow for the product from an interface device; creating a product request data record for the product as a result of identifying the merchant-initiated step; transmitting the product request data record to a competitive analysis engine; creating a search request data record from the product request data record; transmitting the search request data record from the competitive analysis engine to a search request computer; receiving a search result data record from a search result computer; analyzing the search result data record by the competitive analysis engine to create a competitive analysis result data record containing a competitive analysis of the product; transmitting the competitive analysis result data record from the competitive analysis engine to the interface device. In embodiments, the competitive analysis engine may be a component within an e-commerce platform. The competitive analysis engine may be external to an e-commerce platform. The search request data record may be created within an e-commerce platform. The search request data record may be created external to an e-commerce platform. The search result computer may be within an e-commerce platform. The search result computer may be external to an e-commerce platform. The product purchase flow may be located on an offline channel. The product purchase flow may be a draft order. The draft order may include an offline channel and an online channel. The product request data record may utilize a SKU. The product request data record may utilize a UPC. The product request data record may utilize a product name. The search result data record may utilize a SKU. The search result data record may utilize a UPC. The search result data record may utilize a product name. The merchant-initiated step in the product purchase flow may be a product inventory search. The product request data record may be transmitted from the interface device. The search result data record may contain at least one alternate purchasing option for the product. The search request computer may be the same as the search result computer. The competitive analysis may include a price analysis. The competitive analysis may include an inventory analysis. The competitive analysis may include a demand analysis. The competitive analysis may include a value analysis. The method may include the step of retrieving a competitive analysis result data record from a competitive data store. The method may include the step of storing a competitive analysis result data record to a competitive data store. The method may include the step of presenting the competitive analysis of the product to the interface device. The method may include the step of presenting a recommended promotion to the interface device. The recommended promotion may be automatically approved without approval of a manager. The recommended promotion may be a discount as a percentage. The recommended promotion may be a discount as a fixed currency amount. The recommended promotion may be a discount as an increase in quantity of the product. The recommended promotion may be a discount as an upgrade of the product. The recommended promotion may be a discount as a discount on shipping. The recommended promotion may be a discount as a shipping upgrade.

In an aspect, a computer-implemented method for performing a competitive online search of a product is disclosed, including: receiving, from an interface device, an indication of initiation of a product purchase flow for the product; creating a product request data record for the product; transmitting the product request data record to a competitive analysis engine; and receiving a competitive analysis result data record containing a promotion recommendation for the product. In embodiments, the competitive analysis result data record may contain at least one alternate purchasing option for the product. The method may include the step of transmitting at least an aspect of the competitive analysis result data record to the interface device.

In an aspect, a system of combining multi-channel prospective purchases is disclosed, including an e-commerce platform, the e-commerce platform including at least one processor and at least one memory, the e-commerce platform adapted to: receive a first prospective purchase on an offline channel; receive a second prospective purchase on an online channel; and combine the first prospective purchase and the second prospective purchase into a single draft order. In embodiments, the single draft order may properly attribute origination of the first prospective purchase and the second prospective purchase via a salesperson ID associated with the offline channel. The single draft order may properly attribute origination of the first prospective purchase and the second prospective purchase via a store ID associated with the offline channel. The single draft order may properly attribute origination of the first prospective purchase and the second prospective purchase via a location ID associated with the offline channel. The single draft order may properly attribute origination of the first prospective purchase and the second prospective purchase to the offline channel resulting in increased accuracy of sales metrics. The e-commerce platform may be adapted to communicate the single draft order to a customer. The communication of the single draft order to the customer may include a merchant providing checkout services to the customer. The communication of the single draft order to the customer may include providing a draft order identifier to the customer. The draft order identifier may be a link. The draft order identifier may be a QR code. The draft order identifier may be an NFC. The draft order identifier may be provided via SMS. The draft order identifier may be provided via email. The draft order identifier may be provided via an application notification. The draft order identifier may be utilized by a customer device. The communication of the single draft order to the customer may include providing a split-cart user interface. The e-commerce platform may be adapted to convert the single draft order into a single transaction. The conversion of the single draft order to the single transaction may occur via authorization provided on a POS device. The conversion of the single draft order to the single transaction may occur via authorization provided on a merchant device. The conversion of the single draft order to the single transaction may occur via authorization provided on a customer device.

In an aspect, a system for automatically determining a recommended promotion to provide to a customer is disclosed, including an e-commerce platform, the e-commerce platform including at least one processor and at least one memory, the e-commerce platform adapted to: receive a prospective purchase; automatically perform a promotion analysis on a product of the prospective purchase; and automatically determine the recommended promotion based on the promotion analysis. In embodiments, the prospective purchase may originate from an offline channel. The prospective purchase and the customer may be located at an offline channel. The prospective purchase may be a draft order. The draft order may be a multi-channel draft order including an offline channel and an online channel. The promotion analysis may be automatically performed upon a product inventory search by a merchant. The recommended promotion may be automatically approved without approval of a manager. The e-commerce platform may be adapted to communicate the recommended promotion to a merchant. The e-commerce platform may be adapted to communicate the recommended promotion to a customer. The performing of a promotion analysis may utilize a SKU of the product. The performing of a promotion analysis may include performing a price analysis of the product from one or more in a set containing competitor offerings and historical data. The performing of a promotion analysis may include performing an inventory analysis of the product from one or more in a set containing competitor offerings and historical data. The performing of a promotion analysis may include performing a demand analysis of the product. The performing of a promotion analysis may include performing a value analysis of the prospective purchase. The recommended promotion may be a discount as a percentage. The recommended promotion may be a discount as a fixed currency amount. The recommended promotion may be an increase in quantity of the product. The recommended promotion may be an upgrade of the product. The recommended promotion may be a discount on shipping. The recommended promotion may be a free shipping upgrade.

In an aspect, a system for performing a competitive online search of a product is disclosed, including an e-commerce platform, the e-commerce platform including at least one processor and at least one memory, the e-commerce platform adapted to: identify a merchant-initiated step in a product purchase flow of the product; perform the concurrent competitive online search of the product upon the merchant-initiated step of the product purchase flow; and present a result of the concurrent competitive online search. In embodiments, the merchant-initiated step in the product purchase flow may be a product inventory search. The merchant-initiated step in the product purchase flow may be creation of a draft order. The draft order may be a multi-channel draft order including an offline channel and an online channel. The product may be not in inventory at a store location where the merchant-initiated step occurs. The result of the concurrent competitive online search may be presented to a merchant. The result of the concurrent competitive online search may be presented to a customer. The result may include automatically determine a recommended promotion. The recommended promotion may be a discount. The recommended promotion may be automatically applied to a purchase transaction for the product. The presenting of the result may include presenting the recommended promotion on a merchant device. The presenting of the result may include presenting the recommended promotion on a POS device. The merchant-initiated step in the product purchase flow may be a product inventory search; the product may be not in inventory at a store location where the merchant-initiated step occurs; presenting the result may include automatically determining a recommended discount; the result of the concurrent competitive online search may be presented to a merchant device; and the recommended discount may be automatically approved without a review by a manager.

In an aspect, a system for performing a competitive online search of a product is disclosed, including an e-commerce platform, the e-commerce platform including at least one processor and at least one memory, the e-commerce platform adapted to: identify a merchant-initiated step in a product purchase flow for the product from an interface device; create a product request data record for the product as a result of identifying the merchant-initiated step; transmit the product request data record to a competitive analysis engine; create a search request data record from the product request data record; transmit the search request data record from the competitive analysis engine to a search request computer; receive a search result data record from a search result computer; analyze the search result data record by the competitive analysis engine to create a competitive analysis result data record containing a competitive analysis of the product; and transmit the competitive analysis result data record from the competitive analysis engine to the interface device. In embodiments, the competitive analysis engine may be a component within the e-commerce platform. The competitive analysis engine may be external to the e-commerce platform. The search request data record may be created within the e-commerce platform. The search request data record may be created external to the e-commerce platform. The search result computer may be within the e-commerce platform. The search result computer may be external to the e-commerce platform. The product purchase flow may be located on an offline channel. The product purchase flow may be a draft order. The draft order may include an offline channel and an online channel. The product request data record may utilize a SKU. The product request data record may utilize a UPC. The product request data record may utilize a product name. The search result data record may utilize a SKU. The search result data record may utilize a UPC. The search result data record may utilize a product name. The merchant-initiated step in the product purchase flow may be a product inventory search. The product request data record may be transmitted from the interface device. The search result data record may contain at least one alternate purchasing option for the product. The search request computer may be the same as the search result computer. The competitive analysis may include a price analysis. The competitive analysis may include an inventory analysis. The competitive analysis may include a demand analysis. The competitive analysis may include a value analysis. The e-commerce platform may be adapted to retrieve a competitive analysis result data record from a competitive data store. The e-commerce platform may be adapted to store a competitive analysis result data record to a competitive data store. The e-commerce platform may be adapted to present the competitive analysis of the product to the interface device. The e-commerce platform may be adapted to present a recommended promotion to the interface device. The recommended promotion may be automatically approved without approval of a manager. The recommended promotion may be a discount as a percentage. The recommended promotion may be a discount as a fixed currency amount. The recommended promotion may be a discount as an increase in quantity of the product. The recommended promotion may be a discount as an upgrade of the product. The recommended promotion may be a discount as a discount on shipping. The recommended promotion may be a discount as a shipping upgrade.

In an aspect, a system for performing a competitive online search of a product is disclosed, including an e-commerce platform, the e-commerce platform including at least one processor and at least one memory, the e-commerce platform adapted to: receive, from an interface device, an indication of initiation of a product purchase flow for the product; create a product request data record for the product; transmit the product request data record to a competitive analysis engine; and receive a competitive analysis result data record containing a promotion recommendation for the product. In embodiments, the competitive analysis result data record may contain at least one alternate purchasing option for the product. The e-commerce platform may be adapted to transmit at least an aspect of the competitive analysis result data record to the interface device.

### BRIEF DESCRIPTION OF THE FIGURES

FIG. 1 depicts an embodiment of an e-commerce platform.

FIG. 2 depicts an embodiment of a home page of an administrator.

FIG. 3 depicts a logical architecture view of a draft order.

FIG. 4 is a flowchart depicting an embodiment of combining offline and online prospective purchases into a single draft order.

FIG. 5 is a flowchart depicting an embodiment of automatically performing a promotion analysis and determining a recommended promotion.

FIG. 6 depicts an embodiment of a draft order or shopping cart screen.

FIG. 7 depicts an embodiment of a draft order or cart modifier screen.

FIG. 8 depicts an embodiment of an items to ship screen.

FIG. 9 depicts an embodiment of a split-draft order or split-cart screen.

FIG. 10 depicts an embodiment of a split-draft order or split-cart screen with results of a competitive price analysis.

FIG. 11 depicts a logical architecture view of an embodiment for performing a competitive analysis.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

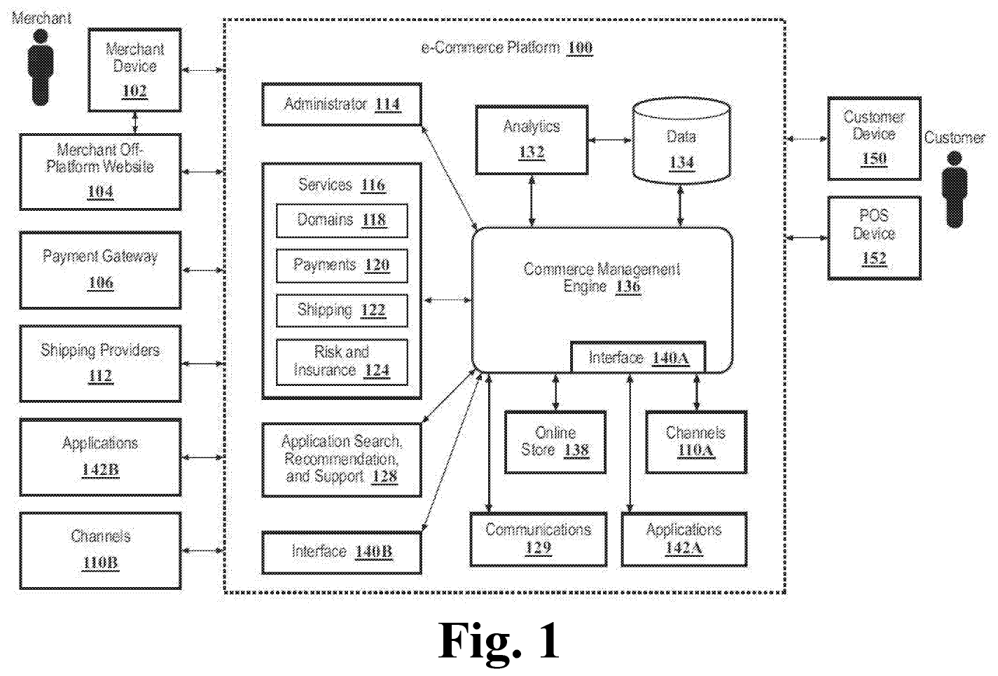

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

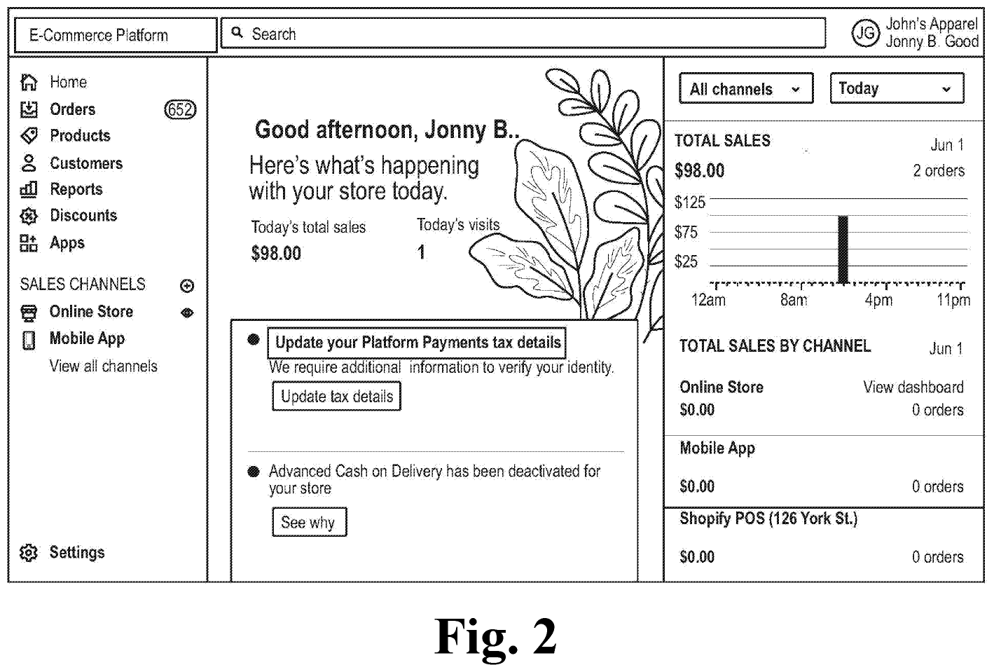

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

When a retail store sale is lost to an online store, this results in: (i) one or more salespersons being shorted on their commissions and/or attribution of the sale despite providing services to the customer, (ii) a decreased product inventory turnover at the retail store, and (iii) the retail store's sales metrics being inaccurately represented with respect to the true efforts behind the sale. Much less, the customer may be inconvenienced as they are unable to complete their transaction on the premises (e.g. at the retail store), and they do not receive their product(s) immediately as they must wait for the product(s) to be delivered through an online fulfillment/shipping process.

In even worse situations, the customer may choose a different merchant/source and the sale to the merchant is entirely lost. Although some merchants or retail stores attempt to minimize these problems by assisting the customer with an online order at the merchant's online store under courtesy of good customer service, the purchase ultimately occurs at the online store. As such, the retail store and its salesperson still do not receive proper attribution of the sale resulting in inaccurate sales metrics reported for the online sale.

In other scenarios, a merchant's retail store may fulfill a portion of goods/services requested by a customer, while arranging the fulfillment of the remaining goods/services from the merchant's online channel. However, in the prior art under this scenario the customer's purchases are two separate transactions (e.g. one at the retail store and the other at the online store). As earlier noted, the online transaction (e.g. even while the customer may be physically in the retail store at the time) results in inaccurately reported sales attribution resulting in inaccurate reported metrics.

Thus, what is needed in the art is a new approach for a merchant to seamlessly prepare an order for a customer, with one or more products from an offline channel or an online channel, or both, and create a single order where the sales attribution/metrics are properly reported.

Given problems in the scenarios described herein, embodiments disclosed herein address the needs for a common or single draft order eliminating multiple transactions on different channels. This provides a superior customer experience and accurately reports the sales attribution/metrics. In embodiments, a single draft order may be created to include one or more products from either offline channels (e.g. a physical store) or online channels (e.g. an online store), or both, wherein the draft order may be immediately or later converted into a single or common transaction.

The single draft order may also properly attribute sales resulting for accurate reported metrics for all products on the single draft order, regardless of the channel where the products originate. More particularly, the single draft order may simplify and correctly attribute efforts to the proper salesperson (e.g. for commissions, monthly sales reporting, and the like) rendering services to the customer, possibly through a salesperson ID or other identifier. Proper credit can also be attributed to the proper retail store or location (e.g. city, state or region) through a store ID, location ID or other identifier, resulting in more accurate sales metrics.

Similarly, discounts or promotions provided to incentivize the purchase or enhance the customer experience may also be tracked more effectively through the single draft order utilizing a promotion ID or other identifier. In embodiments, some promotions that may be a single-use promotion may only be utilized on a single draft order (a single-use promotion would not be able to be offered, applied or tracked across multiple transactions under the prior art). As such, salesperson ID, store ID, location ID, promotion ID or other identification codes/values may be implemented in conjunction with a single draft order to properly attribute efforts or sales credit, resulting in increased accuracy of reported metrics for the transaction.

In another aspect, sales attribution, reported metrics and other data originating from a single transaction more accurately reports the entire scope of the transaction (since the transaction is not artificially split into smaller transactions for each channel or separating online from offline purchases in separate orders) with respect to: total transaction amount, average amount of the transaction, average unit price per invoice, average discount(s) provided, origin of the transaction (e.g. advertisement, web search, referral) and the like. In this way, commissions, financial figures and sales/marketing data may be more accurately reported to the appropriate recipients in the merchant's organization, rather than scattered, split or skewed across multiple transactions occurring on different channels (when in fact they should be combined within the same single transaction). It is noted that other or additional identification codes may be utilized, so that the reported metrics and data may correctly calculate, track or report tax, shipping or other contexts of transactions.

As noted herein, a single draft order may be created using interfaces, devices and computing resources of the e-commerce platform 100. A single draft order may include either offline or online products, or both, and be created using a variety of methods, interfaces and devices. A single draft order may be created in a variety of locations, including but not limited to a retail store, a merchant back office, or in any location for the customer (e.g. via phone, mobile device, personal computer, and the like).

For example, a merchant may create a draft order on a merchant device 102 (e.g. a merchant facing computer checkout screen, cash register, POS device 152 and the like) thereby assisting the customer while present at the physical store. Similarly, the draft order may be created on a merchant device 102 while the customer is not present in a store (e.g. the customer communicates with a merchant representative by phone, chat or other means) and the draft order is created on a merchant device 102. In embodiments, a manager or other staff member may assist the customer and create the draft order on a draft order interface or screen on a computing device.

Alternatively, a draft order may be created on a POS device 152 located in a retail store, with or without assistance by the merchant. Similarly, whether inside or outside a retail store, and with or without the assistance of a merchant representative, a customer may create a draft order on a customer device 150. As it can be appreciated, in embodiments, the methods, interfaces and devices that may be used are primarily performing a function to identify and add products from offline and/or online channels.

In embodiments, once the products are identified (e.g. added to a customer's cart, bag or container) for a prospective draft order, the combining of the product(s) from their associated offline/online channels into a single draft order may be processed through the computing devices described herein (e.g. a merchant device 102, POS device 152, customer device 150, and the like), and/or through the computing capabilities of the e-commerce platform 100.

In embodiments, a draft order may also be configured to provide flexibility in purchasing products that are in stock, in the process of being reconditioned, backordered, out-of-stock, in the process of being re-stocked, in the process of being manufactured or created or in other product availability categories, or any combination thereof.

In embodiments, after creating the draft order, it may be optionally presented or communicated to the customer (or another user) in a variety of forms, mediums and devices, including but not limited to:

(i) providing the draft order to a merchant device 102, allowing the merchant to present the draft order verbally or visually to the customer (e.g. during the checkout process at a retail store counter);

(ii) providing the draft order to a POS device 152, thereby allowing the customer to commence a self-checkout process or commence checkout with the assistance of a merchant representative; or

(iii) providing the draft order to a customer device 150 such as via a draft order identifier. The draft order identifier may allow the customer to commence checkout or payment on a customer device 150 (e.g. smartphone, tablet, personal computer, and the like) or other computing device.

A draft order identifier may take a variety of forms and be communicated through a variety of mediums, including but not limited to: a link (e.g. a web/Internet alphanumeric link that when entered/selected in a browser loads the draft order into a page on the browser), a quick response (QR) code, a barcode, a near field communication (NFC), simple messaging service (SMS) message (e.g. text), email message, or application notification (e.g. notification sent directly to an application on a mobile device).

In embodiments, after communication of the draft order, the single draft order may be optionally converted to a transaction through a checkout or payment process, whether offline or online. More particularly, the single draft order may allow the customer to verify the order and provide a single payment, regardless of the respective channels of the products. In doing so, financing, taxation, discounts and other beneficial purchase terms may be simplified and applied to the entire, single draft order/transaction.

In embodiments, to incentivize a customer to complete a purchase (e.g., convert a draft order into a transaction), a promotion may be offered to the customer to apply to a prospective purchase or a draft order. Such a promotion may be recommended by the e-commerce platform 100 and provided to a merchant who may decide to provide it to a customer, presented by a merchant representative to the customer, or it may be provided directly to the customer. In doing so, such a promotion may be applied to the entire draft order that may or may not include multiple products from multiple channels.

Examples of such a recommended promotion include but are not limited to: a discount in the form of a percentage of the purchase (e.g. 15% off the draft order), a discount in the form of a fixed currency amount (e.g. $10 off), an increase in the quantity of product provided (e.g. customer receives an additional unit or additional 20% of product at no extra charge), an upgrade of the product(s) (e.g. a customer receives an upgraded product model at the same price as a base model that is not in stock), a discount on shipping, or a free shipping upgrade (e.g. priority shipping versus ground shipping at no additional charge).

In embodiments, a promotion analysis may be performed by the e-commerce platform 100, thereafter determining a promotion to offer to a customer for a prospective purchase. Such a promotion analysis may be manually triggered by the merchant or initiated based on one or more events detected by the e-commerce platform 100 such as a product inventory search by a merchant or any other merchant-initiated step of a product purchase flow. The promotion analysis may be performed concurrently with the product inventory search or other merchant-initiated step of the product purchase flow.

Such a promotion analysis may also be initiated by a customer-initiated event or step in a product purchase flow. For example, a promotion analysis may be commenced when a product is identified in a customer's shopping cart, whether the shopping cart is virtual in an online channel or whether the shopping cart is physical (e.g. using RFID tags, cameras or other technology to identify a product in the possession of the customer).

Other conditions or triggers for the e-commerce platform 100 to initiate the promotion analysis may be tied to any identifiable interest in a product or prospective customer determined by the platform 100 without a merchant-initiated or customer-initiated step in the product purchase flow. For example, a promotion analysis may be initiated when the platform 100 detects or recognizes the presence of a customer in a retail store (e.g. biometric/facial recognition matched to a specific customer). In embodiments, a promotion analysis may be initiated based on the platform 100 determining a customer interest in one or more products within a retail store (e.g. based on a customer proximity to the products).

In embodiments, a promotion analysis may utilize stock keeping unit (SKU) or other identification codes to keep the promotion analysis accurate and specific (e.g. targeting specific products). In this manner, SKU codes may be useful assessing specific inventory available to the merchant as well as assessing inventory held by competing merchants, as product descriptions may be less specific and contain customizations that may skew an analysis. For example, computer products may have various memory and storage sizes available but may have a common product description, and such ambiguities may be minimized or eliminated if employing a SKU code for the promotion analysis.

In embodiments, a promotion analysis may consist of or include one or more competitive online searches including but not limited to analyses or searches as to price, inventory, demand, shipping cost or delivery time by competing third party merchants. These competitive online searches may be directed toward any product identified or selected for that purpose on the platform 100 by a merchant or a customer.

In embodiments, a variety of sub-analyses may be included when performing the promotion analysis. For example, a price analysis on one or more products may be performed as part of the promotion analysis to assess competitors' prices (e.g. lookup pricing at competitors' stores) or assess historical pricing (e.g. in recent months or years, during various seasons, during holidays or other attributes). An inventory analysis may also be performed to check a merchant's internal inventory as well as a competitor's inventory, to determine availability to the customer as it may affect pricing or other sale terms. A demand analysis may also be performed (e.g. historical or current sales figures) to determine whether the product is selling well, selling poorly, has increasing or decreasing sales over time, or other helpful data.

Other analyses may also be performed within the promotion analysis, which are less directed toward the product(s), and more directed toward the value of a potential order being converted to a transaction. For example, a value analysis may be performed to determine a certain value to the merchant in establishing a new customer. A value analysis may be performed to determine the value of reducing stock where the product(s) are on a closeout status, and the like. Of course, the analyses herein are suggestive only, and other analyses can be performed relating to other draft order, price, inventory, demand, value, retail, online, tax, shipping, handling or other commerce factors.

In embodiments, after completing a concurrent competitive online search or promotion analysis, the results of the concurrent competitive online search or promotion analysis may be presented or communicated to the merchant, the merchant representative, the customer or other parties through various devices (e.g. merchant device 102, POS device 152, customer device 150, and the like). Alternatively, or in addition, the promotion analysis may be utilized to determine a recommended promotion.

More particularly, the e-commerce platform 100 may be configured to determine a promotion to ultimately offer the customer (e.g. which can be communicated to the merchant first, or directly communicated to the customer). The promotion determined by the e-commerce platform 100 may be specifically tailored to a draft order as a whole (e.g. developing a new customer), products within or associated with the draft order (e.g. discounts on specific closeout products), or the customer (e.g. buying habits, historical purchases, preferences directed toward increased quantity, discounts or shipping upgrades, and the like).

In embodiments, since a recommended promotion is derived and determined by the e-commerce platform 100, the recommended promotion may be: offered by a merchant representative, automatically applied to a prospective purchase or draft order, or otherwise provided to a customer—all without manager approval, if configured. Alleviating the manager approval requirement thereby makes a promotion available to all salespersons and avoids the delays/hassles of acquiring manager approval.

More particularly, the recommended promotion may be communicated on a merchant device 102, such that a merchant representative may communicate the availability of the promotion to the customer as an incentive to convert the draft order to a transaction on the premises. Alternatively, the promotion may be communicated directly to a POS device 152, such that the promotion is directly communicated to the customer. In embodiments, the promotion may be provided such that the customer can later (such as after a customer leaves the premises) apply the promotion.

Or, in the case of a draft order identifier being communicated to a customer device 150, the promotion may be automatically applied, communicated as available or otherwise provided to the customer through the customer device 150.

In embodiments, a concurrent competitive online search may be performed during a product or inventory search (e.g., for products not in inventory at the store location, but at a different store or inventory location), during a merchant-initiated (such as on a POS device 152 or online) product purchase flow and/or when a draft order is created and the results of the competitive search presented to the merchant (or possibly directly to the customer) and possibly recommending a promotion depending on the results.

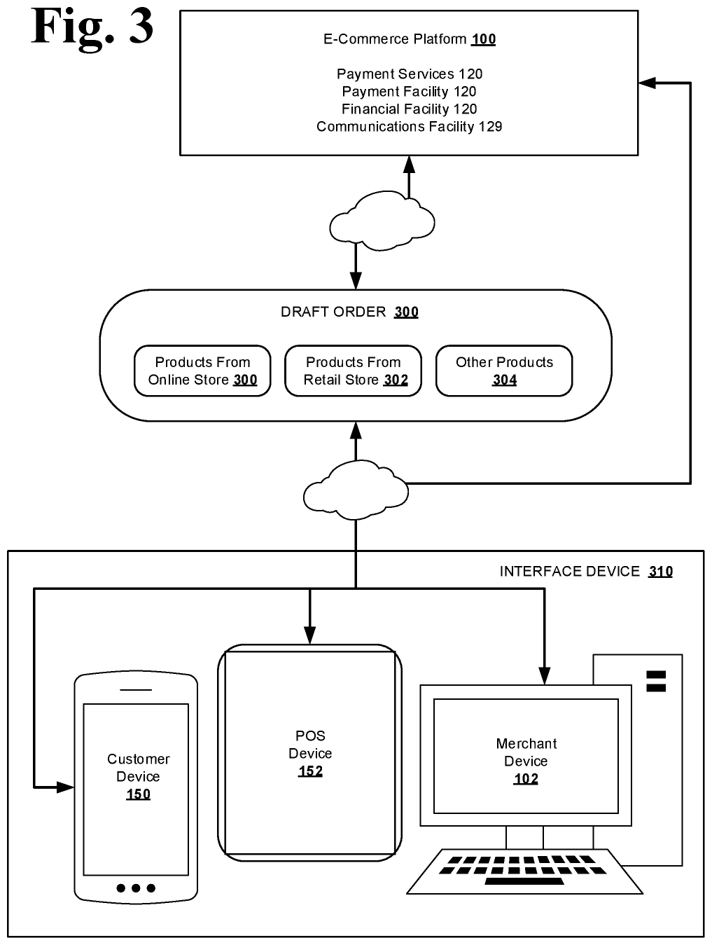

In FIG. 3, a logical architecture view of a draft order is illustrated, including an e-commerce platform 100, a draft order 300 and an interface device 310.

The draft order 300 may include any single product or combination of products, such as: one or more products from an online store 300, one or more products from a retail store 302 or other products 304 from other channels.

The interface device 310 may include a customer device 150, a POS device 152, a merchant device 102 or other devices capable of computing or providing an interface (not shown) to a merchant (not shown) or customer (not shown) to create, communicate or convert a draft order 300 into a single transaction (not shown).

As illustrated by the interconnecting arrows, the draft order 300 may be created, administrated or communicated between the e-commerce platform 100 and the interface device 310 through conventional communications means (e.g. wireless, wired or other communication means).

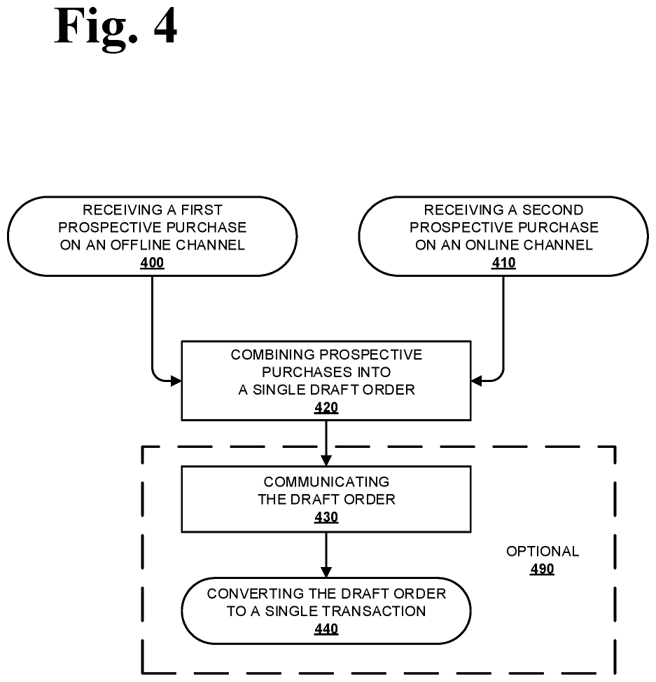

Turning to FIG. 4, a flowchart illustrates an embodiment of combining offline and online prospective purchases into a single order.

In step 400, a first prospective purchase on an offline channel is received (e.g. a product scanned at a retail store, placed in a cart, and the like). In step 410, a second prospective purchase on an online channel is received (e.g. a product is searched, browsed or added to a cart, and the like). Steps 400 and 410 may occur in any order or simultaneously without departing from the spirit of the embodiment.

In step 420, the first prospective purchase of step 400 and the second prospective purchase of step 410 are combined into a single draft order. As described herein, the combining of these prospective purchases in step 420 may be processed by the e-commerce platform 100 or an interface device 310 of FIG. 3, or a combination thereof.

In some embodiments, the process of combining prospective purchases into a single draft order is completed in step 420. However, optional steps 490 may also be included in other embodiments.

In optional step 430, the draft order created in step 420 is communicated to a merchant (not shown) or a customer (not shown) as described herein, such as through an interface device 310.

In optional step 440, the draft order created in step 420, and optionally communicated in step 430, may also be converted (e.g. verified, payment rendered) into a single transaction.

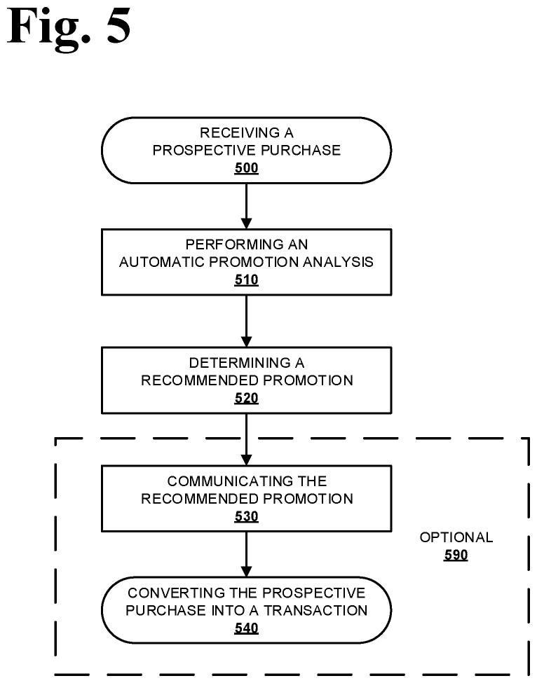

Turning to FIG. 5, a flowchart illustrates an embodiment for performing a promotion analysis and determining a recommended promotion.

In step 500, a first prospective purchase is detected or received (e.g. product scanned at a retail store, searched for in inventory, placed in a virtual or physical shopping cart, and the like). The prospective purchase may originate from an offline channel, online channel or other source.

In step 510, a promotion analysis is performed. The performing of the promotion analysis 510 may be performed by the e-commerce platform 100, an interface device 310, or any combination thereof. As described herein, the promotion analysis may be automated and include a competitive online search for one or more products identified for that purpose during a product search or a purchase event. Step 510 may also include various sub-analyses (e.g. price analysis, inventory analysis, demand analysis, value analysis, and the like).

In step 520, a recommended promotion is determined by the e-commerce platform 100, an interface device 310, or any combination thereof. As described herein, the recommended promotion may include multiple promotions, that is: discounts, incentives, upgrades or other offerings intended to incentivize a customer (not shown) to convert the prospective purchase into a transaction.

In some embodiments, the process of performing a promotion analysis and determining a recommended promotion is complete in step 520; however, optional steps 590 may also be included in other embodiments.

In optional step 530, the recommended promotion determined in step 520 is communicated is to a merchant (not shown) or a customer (not shown) as described herein, such as through an interface device 310.

In optional step 540, the prospective purchase received in step 500 is converted (e.g. verified, payment rendered) into a transaction.

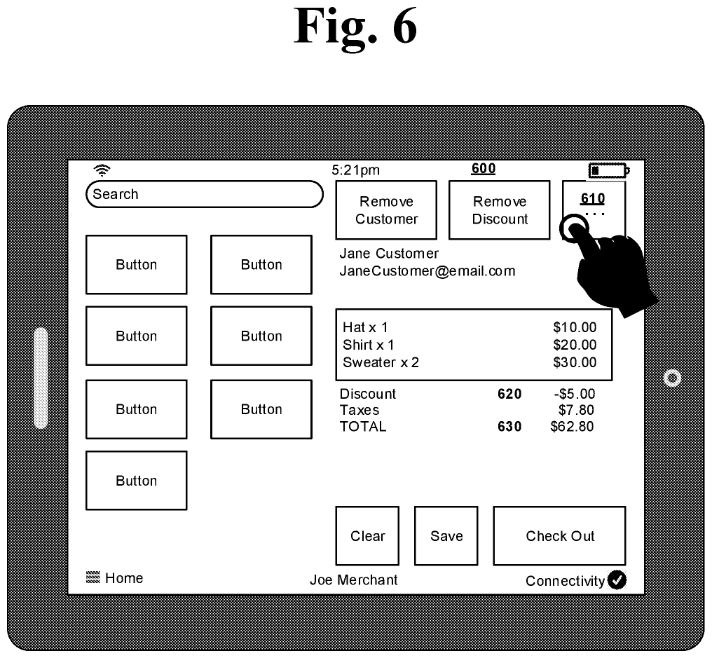

In embodiments, a draft order may be created from an administrative screen, a merchant device 102, a POS device 152, an online store 138, a customer device 150, a website, or virtually any other interface or device allowing the user (e.g. merchant, customer service representative or customer) to combine offline or online channel products into the draft order. It is further understood that the designs of various user interfaces or screens in FIGS. 6 through 10 are merely represented on a tablet computer for purposes of this disclosure, but may be implemented on any device noted above, or any computing device without departing from embodiments disclosed herein.

Turning to FIG. 6, an embodiment draft order screen 600 is illustrated. As used herein a draft order screen or user interface may be a shopping card screen or user interface. More particularly, the draft order includes a hat, a shirt and two sweaters. After an in-store discount 620 of $5.00 is applied, a total price 630 of $62.80 is reflected.

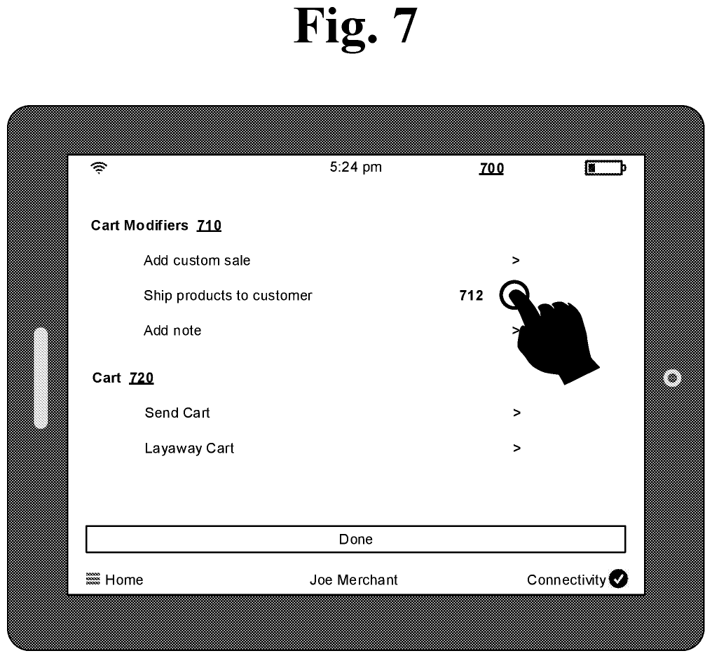

However, by way of example assume that the two sweaters are not in stock at the store. On this occasion, the user (e.g. customer service representative or customer) may touch button 610 (as illustrated by the finger tap, but in other embodiments, throughout, the finger tap may be replaced by other means of user input, such as a keyboard, mouse or trackpad) to designate that the two sweaters be shipped from an online store or source. Upon touching button 610, a draft order or cart modifier screen 700 appears as illustrated by FIG. 7.

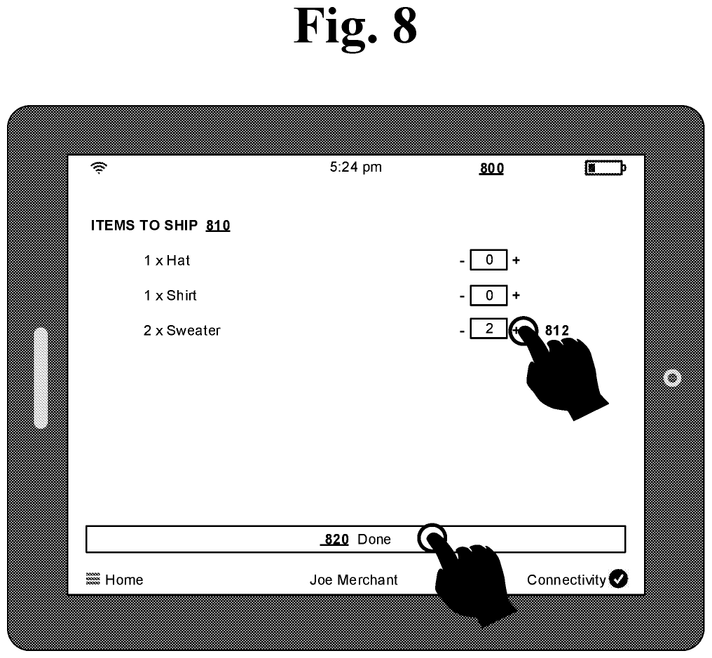

FIG. 7 depicts a draft order or cart modifier screen 700 with two sections of commands, a cart modifiers section 710 and a cart actions section 720. As illustrated, a tap of a ship products to customer button 712 within the cart modifiers section 710 may allow certain items in the shopping cart (not illustrated) to be designated to be shipped to the customer. Upon touching button 712, an items to ship screen 800 appears as illustrated by FIG. 8.

FIG. 8 depicts an items to ship screen 800 with an items to ship section 810 having various items (e.g. hat, shirt, sweaters) that may be designated as to be shipped to a customer. As illustrated, a tap of the plus sign 812 increases the quantity of sweaters to be shipped to the customer (e.g. rather than be tendered at the store).

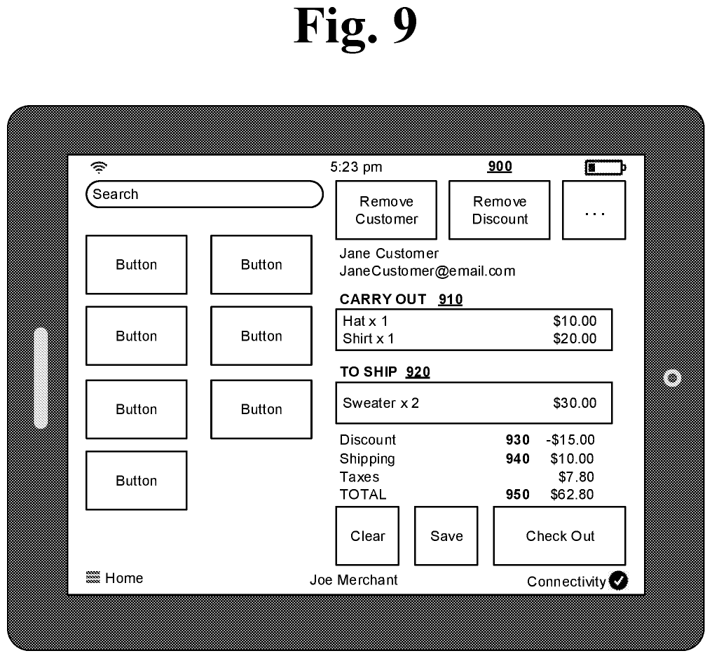

After the quantity of items to be shipped is designated (e.g. in this case “2” sweaters), then upon a tap of done button 820, a split-draft order or split-cart shopping cart screen 900 appears as illustrated in FIG. 9.

FIG. 9 depicts a split-draft order or split-cart shopping cart screen 900 having both a “carry out” offline channel section 910 and a “to ship” online channel section 920. As illustrated, the hat and shirt are to be tendered at the store (within offline channel section 910) and the two sweaters are to be shipped to the customer (within online channel section 920), with both items appearing on the same split-draft order or split-cart shopping cart screen 900.

In embodiments, the split-draft order or split-cart shopping cart screen 900 may reflect a discount 930, a shipping amount 940, taxes and a total price 950 for products from both sections 910 and 920. It is further noted that in the example provided, the discount 930 has been calculated to offset the additional shipping amount 940. This is reflected by the total price 950 of $62.80 which matches the total price 630 from FIG. 6 (e.g. the calculated price if all products were purchased in the store).

In embodiments, the e-commerce platform 100 may be configured such that the system recognizes inventory or lack of inventory of products. Thus, the screens represented by FIGS. 7 and 8 may be automatically bypassed, such that items not in stock at a particular store are automatically configured as items to be shipped and reflected in FIG. 9. Thus, the workflow to a user may proceed from FIG. 6 directly to FIG. 9 without the need to designate items to be shipped in FIGS. 7 and 8.

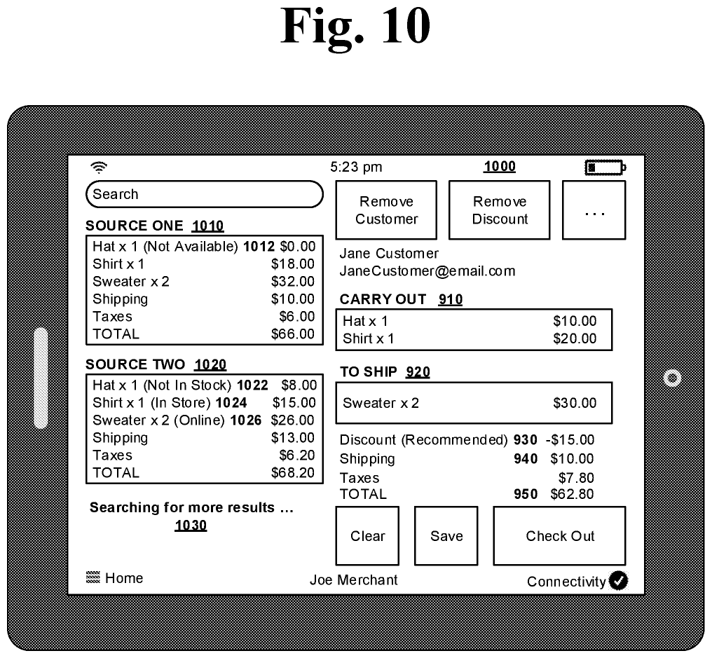

FIG. 10 illustrates a split-cart shopping cart screen 1000 similar to the split-cart shopping cart screen 900 shown in FIG. 9. However, the split-cart shopping cart screen 1000 provides for display of the results of a price analysis such as considering other inventory sources (for example, from the same merchant) or from competing third-party merchants. More particularly, pricing for the same products at “Source One” (which may be a warehouse fulfilling online orders for the merchant) results 1010 is reflected, together with shipping, taxes and a total price. Additional status, inventory or other information may be provided about a product within the price analysis, as reflected by the “Not Available” status 1012 of the hat product in the results 1010.

Similarly, pricing for the same products at “Source Two” results 1020 is also reflected. In this case, only certain products may be in stock and certain products may be available only in-store or online. More particularly, the hat product reflects a “Not In Stock” status 1022 (e.g. the product is not in stock right now, but is likely to be available later), the shirt product reflects an “In Store” status 1024 (e.g. not available online but in physical stores), and the sweater products reflect an “Online” only status 1026 (e.g. not available in stores but available online). Of course, the above are merely examples, and other status, inventory or other information may be presented within a price analysis as desired depending upon the application.

Other features may be configured within the price analysis, such as making the results (e.g. 1010 and 1020) or individual product lines (e.g. 1012, 1022-1026) into active links such that a merchant or customer can receive further detail by clicking or tapping onto the screen location where further inquiry is desired.

In embodiments, the price analysis and search may begin in response to products being added to the draft order or cart (such as when a product is out of stock at the location where the draft order is being created) and the results 1010 and results 1020 may be populated and presented on the split-cart shopping cart screen 1000 as these results become available. Notifier 1030 illustrates that further results may be pending if the search is ongoing and is continuing. If more results are found, then subsequent results may be populated and presented in the space occupied by notifier 1030 or in a user interface element with scrolling functionality. Similar user interfaces may be provided where the draft order or cart is not split among online and offline channels.

As noted in FIG. 10, a discount 930 may be a “Recommended” discount provided automatically (as illustrated), by request of the user (not shown), or manually provided by the user (not shown). Similar to the discount entered in discount 930 on FIG. 9, the discount 930 in FIG. 10 has been automatically calculated and recommended to offset the additional shipping amount 940 with a combined draft order, so that the total price 950 of $62.80 matches the total price 630 from FIG. 6 (e.g. the calculated price if all products were purchased in the store).

It is understood that the designs and features of FIGS. 6 through 10 are all merely suggestive, and that the data fields, labels, buttons, screens and user interface components may be positioned, designed or configured in many different configurations.

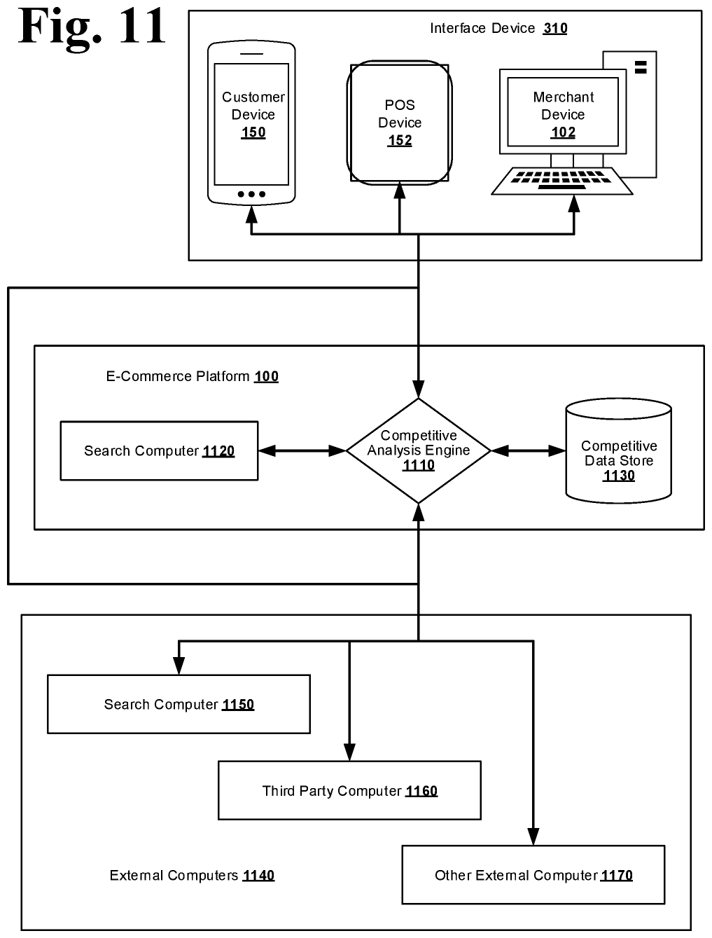

FIG. 11 depicts a logical architecture view of an embodiment for performing a competitive analysis. More particularly, the logical architecture view shows the data communications or transmissions between an interface device 310, an e-commerce platform 100 and external computers 1140.

In embodiments, the external computers 1140 may include one or more search computers 1150, one or more third party computers 1160, or other external computers 1170. For example, a search computer 1150 may be a search computer (e.g. providing a search engine such as GOOGLE®, BING® and the like) capable of providing search results. A third party computer 1160 may be an external server hosting a third party e-commerce store (e.g. WALMART®, CABELA'S® and the like) capable of returning product pricing, inventory or other information. An other external computer 1170 may be any other computer which provides information useful to a competitive analysis, whether pricing, product details, reviews or other information (e.g. product manufacturer website, product review website, product forums, and the like).

The e-commerce platform 100 as illustrated may further include a competitive analysis engine 1110. The competitive analysis engine 1110 may be responsible for receiving requests and transmitting results to an interface device 310, as well as transmitting requests and receiving results with external computers 1140. The competitive analysis engine 1110 may also collate, process and analyze results provided by a search computer 1120 located within the e-commerce platform 100, or results provided by external computers 1140.

The competitive analysis engine 1110 may store and retrieve information or data in a competitive data store 1130. As such, data from a competitive analysis that has been prepared by a competitive analysis engine 1110 may be stored in the competitive data store 1130 for later retrieval by the competitive analysis engine 1110. In other embodiments, a competitive analysis engine (not as illustrated) or competitive data store 1130 may instead be an external computer 1140 or resource outside of the e-commerce platform 100.

In embodiments, performing a concurrent competitive online search may be commenced by identification of a product within a product purchase flow. The identification may be a merchant-initiated step such as a product inventory search performed on a merchant device, or may be any other action taken with respect to a product on any interface device 310 or device within the e-commerce platform 100.

When such a step with respect to a product is identified, a product request data record may be created. The product request data record may contain fields and data such as a manufacturer name, product name, a SKU or UPC code, and other information which may be helpful for performing a product search and creating a competitive analysis. The product request data record may be created by an interface device 310 or by a computer or processor in the e-commerce platform 100 such as the competitive analysis engine 1110.

The product request data record may be transmitted to a competitive analysis engine 1110. The competitive analysis engine 1110 may create a search request data record from the product request data record, wherein the search request data record may include a collection of data or information to be provided to a search request computer (e.g. a search computer receiving all or a portion of the search request data record). The search request data record may contain similar data to the product request data record, but may alternatively or also contain specific data to efficiently perform a search on a search engine, such as data fields configured for a specific API. The search request data record may be provided to an internal search computer 1120, an external search computer 1150, a third party computer 1160 or an other external computer 1170.

A search result data record may be received from a search result computer (e.g. a search computer transmitting the search result data record to the competitive analysis engine 1110). The search request computer may be the same as the search result computer, (e.g. the same search computer whether internal or external), or the search results may be received from a different computer than the computer where the search was requested. The search result data record may contain purchasing options within the e-commerce platform 100 (e.g. same merchant or different merchant within the e-commerce platform 100) and/or one or more alternate purchasing options for the product such as purchasing options external to the e-commerce platform 100.

The competitive analysis engine 1110 may analyze the search result data record to create a competitive analysis result data record containing a competitive analysis of the product. The competitive analysis result data record may be stored by the competitive analysis engine 1110 in the competitive data store 1130 and later retrieved from the competitive data store 1130.

The competitive analysis through the competitive analysis result data record may be transmitted to and presented on an interface device 310. A recommended promotion may be transmitted within the competitive analysis or separately to an interface device 310. The competitive analysis may include information from offline channels, online channels or a combination thereof.

In embodiments, a variety of benefits may be realized in conjunction with creation of a single draft order, automatic performing of a promotion analysis, determination of a recommended promotion, and combinations thereof. More particularly, these embodiments may be advantageous for a merchant to attract and retain prospective purchases in its retail store(s), agnostic of the source channels (e.g. offline or online) of the products, thereby offering:
Opportunities for additional products at the retail store to be added to the purchase (e.g. impulse purchases);
Opportunities for upselling the customer to a more expensive product, warranty or other add-ons;
Improvement of the customer's experience having a salesperson providing expertise about the product(s), application, installation and assisted checkout;
Reduced handling charges to the merchant, including eliminating the need to package and ship the product(s) since inventory is present and sold on the spot at the retail store;
Possible reduction of payment transaction costs (e.g. typically a card transaction cost may be less (e.g. 0.75% less) when a card/chip is physically presented/swiped);
Possible tax reduction/simplification benefits to the merchant;
Increased turnover of inventory for the retail store (e.g. avoiding financing or holdover charges where inventory sits too long); and
Physically placing the customer in the store, increasing the customer's awareness of the merchant's goods/services, buying membership(s), promotions, and physical location.

Similarly, the customer may realize several benefits from a single draft order at a retail location, which may incorporate products from both offline and online channels:
No need to wait for all the product(s) to be packaged, shipped and arrive at the customer's delivery address;
Possible financing benefits to cover an entire purchase of multiple products across multiple channels (e.g. ability to finance in a single transaction what would be impractical in the prior art of multiple purchases from multiple channels);
Possible promotion benefits (e.g. a discount of 15% off everything) that can be applied to cover the entire single transaction across multiple products or channels;
Possible tax benefits to the customer (e.g. sale made in a single state where there is no sales tax);
Simplified return and refund terms (e.g. the customer can take it back to the store rather than package it, print a label and ship it back).

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4^{th} Generation (4G) networks (e.g. Long Term Evolution (LTE)) or 5^{th} Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method for performing a competitive online search of a product, comprising:
identifying a merchant-initiated step in a product purchase flow of the product;
performing the concurrent competitive online search of the product upon the merchant-initiated step of the product purchase flow; and
presenting a result of the concurrent competitive online search.

2. The computer-implemented method of claim 1 wherein the merchant-initiated step in the product purchase flow is a product inventory search.

3. The computer-implemented method of claim 1 wherein the merchant-initiated step in the product purchase flow is creation of a draft order.

4. The computer-implemented method of claim 3 wherein the draft order is a multi-channel draft order comprising an offline channel and an online channel.

5. The computer-implemented method of claim 1 wherein the product is not in inventory at a store location where the merchant-initiated step occurs.

6. The computer-implemented method of claim 1 wherein the step of presenting the result comprises automatically determining a recommended promotion.

7. The computer-implemented method of claim 6 wherein the recommended promotion is automatically applied to a purchase transaction for the product.

8. The computer-implemented method of claim 1, wherein:
the merchant-initiated step in the product purchase flow is a product inventory search;
the product is not in inventory at a store location where the merchant-initiated step occurs;
the step of presenting the result further comprises automatically determining a recommended discount;
the result of the concurrent competitive online search is presented to a merchant device; and
wherein the recommended discount is automatically applied to a purchase transaction for the product.

9. A computer-implemented method for performing a competitive online search of a product, comprising:
identifying a merchant-initiated step in a product purchase flow for the product from an interface device;
creating a product request data record for the product as a result of identifying the merchant-initiated step;
transmitting the product request data record to a competitive analysis engine;
creating a search request data record from the product request data record;
transmitting the search request data record from the competitive analysis engine to a search request computer;
receiving a search result data record from a search result computer;
analyzing the search result data record by the competitive analysis engine to create a competitive analysis result data record containing a competitive analysis of the product; and
transmitting the competitive analysis result data record from the competitive analysis engine to the interface device.

10. The computer-implemented method of claim 9, wherein the competitive analysis engine is a component within an e-commerce platform.

11. The computer-implemented method of claim 9, wherein the competitive analysis engine is external to an e-commerce platform.

12. The computer-implemented method of claim 9, wherein the search request data record is created within an e-commerce platform.

13. The computer-implemented method of claim 9, wherein the search result computer is within an e-commerce platform.

14. The computer-implemented method of claim 9, wherein the search result computer is external to an e-commerce platform.

15. The computer-implemented method of claim 9, wherein the product purchase flow is located on an offline channel.

16. The computer-implemented method of claim 9, wherein the product request data record utilizes a SKU.

17. The computer-implemented method of claim 9, wherein the merchant-initiated step in the product purchase flow is a product inventory search.

18. The computer-implemented method of claim 9, further comprising the step of retrieving a competitive analysis result data record from a competitive data store.

19. The computer-implemented method of claim 9, further comprising the step of storing a competitive analysis result data record to a competitive data store.

20. The computer-implemented method of claim 9, further comprising the step of presenting the competitive analysis of the product to the interface device.

21. The computer-implemented method of claim 9, further comprising the step of presenting a recommended promotion to the interface device.

22. The computer-implemented method of claim 21, wherein the recommended promotion is automatically approved without approval of a manager.

23. A computer-implemented method for performing a competitive online search for a product, comprising:
receiving, from an interface device, an indication of initiation of a product purchase flow for the product;
creating a product request data record for the product;
transmitting the product request data record to a competitive analysis engine; and
receiving a competitive analysis result data record containing a promotion recommendation for the product.

24. The computer-implemented method of claim 23, wherein the competitive analysis result data record contains at least one alternate purchasing option for the product.

25. The computer-implemented method of claim 23, further comprising transmitting at least an aspect of the competitive analysis result data record to the interface device.
